(19) United States
(12) Patent Application Publication
(10) Pub. No.: US 2008/0008166 A1
(43) Pub. Date: Jan. 10, 2008

(54) Method of detecting defective module and signal processing apparatus

(75) Inventor: Tomoko Osaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/544,780

(22) Filed: Oct. 10, 2006

(30) Foreign Application Priority Data
Jun. 20, 2006 (JP) 2006-169524

(51) Int. Cl. H04L 12/50

(52) U.S. Cl. 370/376

(57) ABSTRACT

A method detects a defective module in a signal processing apparatus having modules capable of communicating with each other. The method includes the step of incrementing the number of occurrences of communication failure for each module relevant to communication where a communication failure has occurred, upon occurrence of the communication failure, while monitoring communications among the modules. The method further includes the step of detecting a defective module based on the number occurrences of communication failure for each module incremented in the step of incrementing the number of occurrences of communication failure.

### BACKGROUND OF THE INVENTION

1. Field of the Invention

The present invention relates to a signal processing apparatus having modules that communicate with each other and to a method of detecting a defective module in the signal processing apparatus.

2. Description of the Related Art

In the field of communication, an apparatus such as a signal transmission apparatus is provided with a multiprocessor system including processor modules capable of communicating with each other and a fault-tolerant (FT) function.

FIG. 1 is a diagram showing an example of a multiprocessor system having a FT function.

A multiprocessor system 10 shown in FIG. 1 includes: processor modules (PM) 11_0, 11_1, . . . and 11_{—}n (the number of PMs is “n+1”); dual system control modules (SCM) 12_0 and 12_1: dual shared storage modules (SSM) 13_0 and 13_1; dual system buses 14_0 and 14_1; dual maintenance buses 15_0 and 15_1; and dual communication adapters 16_0 and 16_1.

The PMs 11_0 through 11_{—}n each perform signal processing in the multiprocessor system 10 while communicating with each other through the system buses 14_0 and 14_1. The contents of the signal processing may be anything and thus will not be described. The duel SCMs 12_0 and 12_1 are modules that monitor communications among the PMs and control the entire multiprocessor system 10. The SCMs 12_0 and 12_1 control each block of the multiprocessor system 10 through the maintenance buses 15_0 and 15_1 while communicating with each other.

The SSMs 13_0 and 13_1 are modules that store data in a dual manner such that data written into the SSM 13_0 (master) is also written into the SSM 13_1 (slave). Once the master SSM 13_0 fails, the slave SSM 13_1 starts serving as a master SSM and maintains the processing under software control.

The dual communication adapters 16_0 and 16_1 each communicate with a host (not shown).

The multiprocessor system 10 as shown in FIG. 1 is fault tolerant because the elements are made dual or multiplex.

However, the multiprocessor system 10 as shown in FIG. 1 has such a drawback that even if a timeout or a parity error occurs as a result of access by one PM to another PM, it is difficult to find out which part has failed.

To overcome such a drawback, some conventional methods may be employed. For example, there are methods of isolating a suspect spot and replacing a component corresponding to the suspect spot with a spare, for example, by assuming the suspect spot based on recorded failure information or by running a test-only program. However, the methods of assuming a suspect spot based on recorded failure information have such a problem that if the assumption is incorrect, recovery from a failure cannot be accomplished and another component needs to be replaced with a spare, which is inefficient. Moreover, the methods employing a test-only program have another problem that they cannot deal with intermittent failures. Specifically, if an intermittent failure occurs, these methods have to power off the system to start running the test-only program. However, once the system is powered off, the failure will never be reproduced and thus a suspect component needs to be replaced at a guess, which is totally unreliable.

Japanese Patent Application Publication No. 7-230432 proposes a technique of monitoring a bus and recording signal values on the bus in a history recording means. Meanwhile, Japanese Patent Application Publication No. 57-168318 proposes a technique of outputting error information upon detection of an error by means of a bus monitoring system.

However, even if history information is thus recorded or error information is thus output, it is still difficult to specify which one of a sender and a receiver has failed or exactly which part has failed in the conventional systems.

### SUMMARY OF THE INVENTION

In view of the foregoing, the present invention provides a method of readily detecting a defective module in a signal processing apparatus having modules capable of communicating with each other, and also provides a signal processing apparatus having a detector that readily detects a defective module.

According to the invention, there is provided a method of detecting a defective module in a signal processing apparatus having a plurality of modules capable of communicating with each other, the method including the steps of:

incrementing the number of occurrences of communication failure for each module relevant to communication where a communication failure has occurred, upon occurrence of the communication failure, while monitoring communications among the modules; and

detecting a defective module based on the number occurrences of communication failure for each module incremented in the step of incrementing the number of occurrences of communication failure.

In the method of the invention, communications among the modules is monitored, and upon occurrence a communication failure, the number of occurrences of communication failure per module relevant to communication where the communication failure has occurred is incremented. Based the incremented number of occurrences of communication failure per module, a defective module can be detected and readily isolated.

In the method according to the invention, the signal processing apparatus may include plural communication paths for communications among the modules, and

the step of incrementing the number of occurrences of communication failure may be a step of incrementing the number of occurrences of communication failure per module and per communication path.

This additional feature makes it possible to isolate a defective module more reliably.

In the method according to the invention, the step of detecting a defective module may be a step of halting a module whose number of occurrences of communication failure is equal to or above a predetermined number while keeping the signal processing apparatus active, and determining that the module is defective when the number of occurrences of communication failure for all other modules after the module is halted is below the predetermined number.

With this more specific feature, it is possible to detect a defective module further readily and reliably.

In the method according to the invention, the step of incrementing the number of occurrences of communication failure may clear the number of occurrences of communication failure per module at predetermined intervals and restarts incrementing.

Repeating the incrementing in this way makes it possible to further readily grasp the failure occurrence status.

According to the invention, there is also provided a signal processing apparatus that includes plural modules communicating with each other, the apparatus including:

an increment section that increments the number of occurrences of communication failure for each module relevant to communication where a communication failure has occurred, upon occurrence of the communication failure, while monitoring communications among the modules; and

a detection section that detects a defective module based on the number occurrences of communication failure for each module incremented by the increment section.

The signal processing apparatus of the invention also includes additional features corresponding to all the above-described various additional features of the method of detecting a defective module, in addition to the basic structure.

As described above, it is possible to readily detect a defective module according to the invention.

### BRIEF DESCRIPTION OF THE DRAWINGS

FIG. 1 is a diagram showing an example of a multiprocessor system having a FT function;

FIG. 2 is a diagram showing an example of a table in which the number of occurrences of communication failure is recorded for each system bus per PM; and

FIG. 3 is a flowchart of processing performed by SCMs.

### DETAILED DESCRIPTION OF THE INVENTION

An embodiment of the present invention will be described.

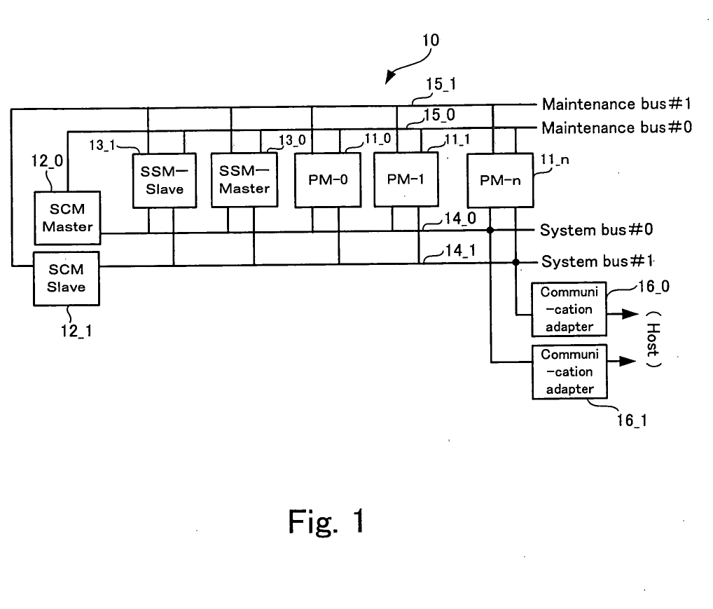

Basically, a multiprocessor system that operates as a signal processing apparatus according to the embodiment of the invention is composed of components similar to those shown in FIG. 1, although the components of the embodiment operate in a quite different manner. Therefore, the reference characters shown in FIG. 1 will be used to describe the embodiment.

The basic configuration of the multiprocessor system according to the embodiment is similar to the multiprocessor system 10 shown in FIG. 1, which has been already described above. Further, the multiprocessor system of the embodiment has the following additional features. In the multiprocessor system of the embodiment, upon being halted and then reactivated, each of PMs 11_0 through 11_{—}n enters a standby state where signal processing cannot be shared with other PMs. Subsequently, the halted and reactivated PM is separated from the system so that it becomes transparent to the system while it is physically present. Any PM in the standby state can be returned to an active state where signal processing can be shared with other PMs.

SCMs 12_0 and 12_1 serve as a master and a slave respectively, and have a system control function and a bus control function to perform control such as prediction control. Once the master SCM 12_0 fails, the slave SCM 12_1 becomes a master SCM and maintains the processing. The SCMs 12_0 and 12_1 have maintenance buses 15_0 and 15_1 as the respective dedicated buses, which are used to access the PMs 11_0 through 11_{—}n or to access each other.

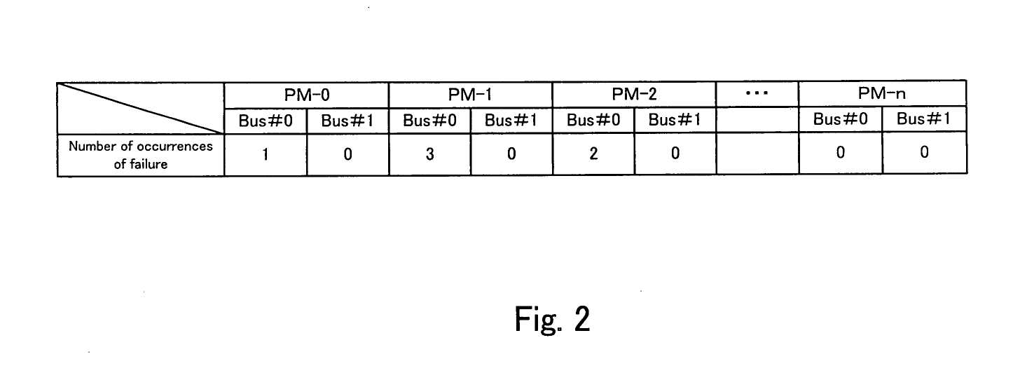

FIG. 2 is a diagram showing an example of a table in which the number of occurrences of communication failure is recorded for each system bus per PM.

The table shown in FIG. 2 is prepared in some area in each of the SSMs 13_0 and 13_1.

The SCMs 12_0 and 12_1 use the respective tables as shown in FIG. 2 in the following manner. Upon detection of a communication failure while monitoring communications among the PMs 11_0 through 11_{—}n, the SCMs 12_0 and 12_1 each add “1” to the value in the field of a system bus used in the current failed communication, for a sender PM and a receiver PM in the own table as shown in FIG. 2, through maintenance buses 15_0 and 15_1. The SCMs 12_0 and 12_1 thus update the tables in the SSMs 13_0 and 13_1. Meanwhile, the PMs 11_0 through 11_{—}n also update these tables through the system buses 14_0 and 14_1. Specifically, upon occurrence of a communication failure, the PMs 11_0 through 11_{—}n each add “1” to the value in the field of a system bus used in the current failed communication for itself as a sender PM and a receiver PM in the tables.

The SCMs 12_0 and 12_1 check the contents of the respective tables as shown in FIG. 2 at time intervals of Tms, and store the checked contents in log areas respectively prepared in the SCMs 12_0 and 12_1 themselves. Upon finding a PM whose number of occurrences of failure is equal to or above a predetermined number (m), the SCMs 12_0 and 12_1 halt and reactivate the found PM. As a result, the found PM enters a standby state after being reactivated, and in turn, other PM that has been already in a standby state is recovered to an active state to maintain the processing.

When there are two or more PMs to be halted at the same time, the SCMs 12_0 and 12_1 halt and reactivate a PM of the lowest number among the PMs, and then clear the respective tables (FIG. 2) back to zero.

Subsequently, when no PM whose number of occurrences of failure is equal to or above the predetermined number (m) is found as result of checking the contents of the tables (FIG. 2), the SCMs 12_0 and 12_1 assume a previously halted and reactivated PM as a cause of failures and separate the PM from the system (to never halt and reactivate the PM again). Even after halt and reactivation of a certain PM, there may be still another PM whose number of occurrences of failure is equal to or above the predetermined number, i.e. the system bus is not yet recovered from a failed condition. In this case, the SCMs 12_0 and 12_1 halt and reactivate such another PM.

Even after all the PMs have been halted and reactivated, the number of occurrences of failure for some PM(s) may be still equal to or above predetermined number (m). In this case, the SCMs 12_0 and 12_1 assume either of themselves as a cause of failures and carry out the following processing. First, the SCMs 12_0 and 12_1 find which one of them is connected to the system bus where the number of occurrences of failure is larger by referring to the log in the log area, and assume the found SCM as a suspect component. Subsequently, the other one of the SCMs 12_0 and 12_1 separates the found SCM from the system and requests the host to prompt an operator for replacement of the separated suspect component (SCM) with a spare.

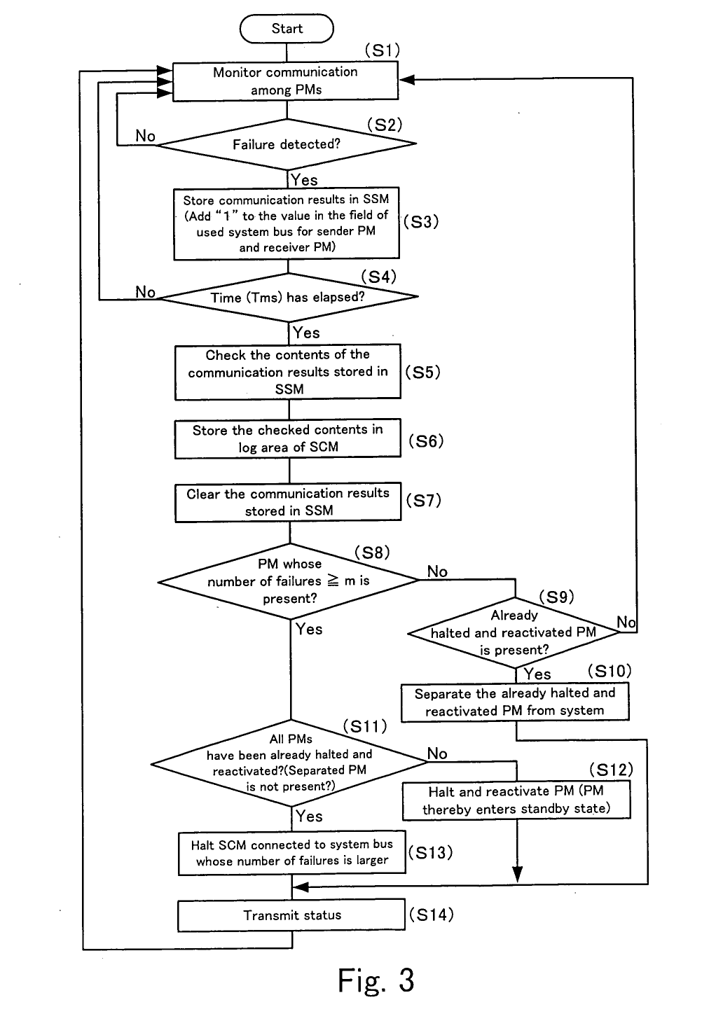

FIG. 3 is a flowchart of the above-described processing performed by the SCMs 12_0 and 12_1. In the following description, the components such as PMs 11_0 through 11_{—}n, SCMs 12_0 and 12_1, and SSMs 13_0 and 13_1 may be mentioned without the reference characters.

First, the SCMs monitor communications among the PMs (step S1). Upon detection of a failure (step S2), the SCMs add “1” to the value in the field corresponding to the system bus used in the current communication for each of a sender PM and a receiver PM, in the tables as shown in FIG. 2 stored in the SSMs (step S3).

After a lapse of Tms during which steps S1 through S3 are repeated (step S4), the SCMs check the contents of the table stored in each of the SSMs showing the results of communications among the PMs (step S5). Subsequently, the SCMs store the contents of the respective tables in the log areas of the SCMs (step S6), and clear the results of communications among the PMs (table shown in FIG. 2) back to zero (step S7). Based on the check results obtained at step S5, the following processing is performed.

The SCMs determine whether there is a PM whose number of occurrences of failure is equal to or above the predetermined number (step S8). If there is no such a PM (No at step S8), the SCMs determine whether there is a previous PM that has been already in a standby state after being halted and reactivated as its number of occurrences of failure was large in the past (step S9). If there is such a previous PM (Yes at step S9), the SCMs separate the previous PM from the system (step S10) and notify the host of the same effect (step S14). If there is no such a previous PM (No at step S9), the flow returns to step S1 to continue the monitoring of communications among the PMs.

If there is a PM whose number of occurrences of failure is equal to or above the predetermined number (Yes at step S8), the SCMs determine whether all the PMs whose number of occurrences of failure are equal to or above the predetermined number have been already halted and reactivated (i.e. whether there is an active PM that is not in a standby state yet) at step S11. If the result is No at step S11, the SCMs halt and reactivate the PM that is not in a standby state yet, thereby causing this PM to enter the standby state (step S12). Subsequently, the SCMs notify the host of the same effect (step S14) and return to step S1 to continue the monitoring of communications among the PMs. If communication failures still occur even after all the PMs have been already once halted and reactivated (Yes at step S11), one of the SCMs connected to a system bus whose number of occurrences of failure is larger is halted (step S13) and the host is notified of the same effect (step S14).

In the conventional system shown in FIG. 1, even if, for example, one of the buses fails, it is possible to maintain the operation of the system by inactivating the failed bus and using the other bus. In this system however, it is necessary to find a failed spot and replace a defective component with another one in order to prevent the influence of the failure from further spreading. Therefore, the system shown in FIG. 1 needs to isolate the failed spot by running a test-only program or the like after terminating the operation of the system.

If an intermittent failure occurs in the system shown in FIG. 1, the system needs to be powered off and then on to isolate a failed spot. However, such an intermittent failure generally never reoccurs after the system is powered off and then on and thus, the system can not but deal with the failure in an unreliable manner, for example, by assuming a suspect component based on remaining log information.

In contrast, according to the embodiment of the invention, it is possible to increase the probability of successful suspect-component isolation and automatic recovery without stopping the system upon occurrence of a failure, which is more advantageous than the conventional system.

Incidentally, the invention is not limited to the system employing multiprocessor modules to perform communications and may be applied to any system in any field.

What is claimed is:

1. A method of detecting a defective module in a signal processing apparatus having a plurality of modules capable of communicating with each other, the method comprising the steps of:
incrementing the number of occurrences of communication failure for each module relevant to communication where a communication failure has occurred, upon occurrence of the communication failure, while monitoring communications among the modules; and
detecting a defective module based on the number occurrences of communication failure for each module incremented in the step of incrementing the number of occurrences of communication failure.

2. The method according to claim 1, wherein the signal processing apparatus comprises a plurality of communication paths for communications among the modules, and
the step of incrementing the number of occurrences of communication failure is a step of incrementing the number of occurrences of communication failure per module and per communication path.

3. The method according to claim 1, wherein the step of detecting a defective module is a step of halting a module whose number of occurrences of communication failure is equal to or above a predetermined number while keeping the signal processing apparatus active, and determining that the module is defective when the number of occurrences of communication failure for all other modules after the module is halted is below the predetermined number.

4. The method according to claim 1, wherein the step of incrementing the number of occurrences of communication failure clears the number of occurrences of communication failure per module at predetermined intervals and restarts incrementing.

5. A signal processing apparatus that includes a plurality of modules communicating with each other, the apparatus comprising:
an increment section that increments the number of occurrences of communication failure for each module relevant to communication where a communication failure has occurred, upon occurrence of the communication failure, while monitoring communications among the modules; and
a detection section that detects a defective module based on the number occurrences of communication failure for each module incremented by the increment section.
